(19) United States
(12) Patent Application Publication
(10) Pub. No.: US 2016/0078413 A1
(43) Pub. Date: Mar. 17, 2016

(54) SYSTEMS AND METHODS FOR EQUIPMENT PERFORMANCE MONITORING AND ALERTS

(71) Applicant: Emerson Electric Co., St. Louis, MO (US)

(72) Inventor: David Drew, St. Louis, MO (US)

(21) Appl. No.: 14/851,612

(22) Filed: Sep. 11, 2015

Related U.S. Application Data
(60) Provisional application No. 62/049,956, filed on Sep. 12, 2014.

(51) Int. Cl. G06Q 10/00; G06Q 30/08

(52) U.S. Cl. CPC G06Q 10/20; G06Q 30/08

(57) ABSTRACT

A method and system for providing maintenance service request information to maintenance service providers using a computer device coupled to a database includes receiving a request for maintenance service, transmitting a request for bids related to the request for maintenance service to bidder computing devices associated with a plurality of respective maintenance service providers, receiving at least one bid for access to identification information of the equipment assembly, evaluating the at least one bid with respect to predetermined evaluation parameters, selecting one of the plurality of prescreened maintenance service providers to award the bid to, notifying the selected one of the plurality of maintenance service providers of the award of the bid, receiving a payment for the award from the selected one of the plurality of maintenance service providers, and transmitting access to identification information of the equipment assembly to the selected one of the plurality of maintenance service providers.

### CROSS-REFERENCE TO RELATED APPLICATION

This application claims priority to U.S. Provisional Patent Application No. 62/049,956 filed Sep. 12, 2014, the entire disclosure of which is hereby incorporated by reference in its entirety.

### FIELD

This disclosure relates generally to monitoring a performance of equipment and, more particularly, to systems and methods for facilitating maintenance of equipment.

### BACKGROUND

Typically, monitoring a condition and/or performance of equipment, such as, heating, ventilating, and air conditioning (HVAC) equipment is often left to technically unsophisticated personnel, such as, a homeowner. For example, a homeowner might be aware that periodic maintenance of their home furnace, heat pump, and/or air conditioning system is required for proper and efficient long-term operation of the equipment. A homeowner may know to change filters regularly, but may not know about cleaning heat transfer coils, ducts, oiling motor bearings, checking heat exchangers for leaks, and the like. Significantly, a homeowner may not be able to detect a decrease in performance of the equipment until the equipment catastrophically fails. Technically unsophisticated personnel, such as, homeowners, often rely on the maintenance service provider that originally installed the equipment to periodically recommend a system checkup. If the original installation maintenance service provider is not vigilant enough, another maintenance service provider may make contact with the homeowner to offer to perform an inspection of the equipment and to recommend services that might be needed.

At least some known modern HVAC equipment have an ability to detect condition and performance issues as they occur or as they trend toward failure. Most such modern equipment is able to alert at least the homeowner that a problem with the equipment is eminent. Other such modern equipment may be able to report to an outside entity trends and or alerts for analysis offsite, or for arranging maintenance personnel to perform an inspection in an effort to remedy the problem.

However, such reporting yields an ad hoc system that may lead to postponement of need service due to the inconvenient nature of the procedure needed to organize the required maintenance.

This Background section is intended to introduce the reader to various aspects of art that may be related to various aspects of the present disclosure, which are described and/or claimed below. This discussion is believed to be helpful in providing the reader with background information to facilitate a better understanding of the various aspects of the present disclosure. Accordingly, it should be understood that these statements are to be read in this light, and not as admissions of prior art.

### BRIEF DESCRIPTION

In one aspect, a method for providing maintenance service request information to maintenance service providers using a computer device coupled to a database includes prescreening a plurality of maintenance service providers, the prescreening evaluating a historical performance of each of the plurality of maintenance service providers and an agreement to quality in future performance of providing maintenance services. The method includes receiving a request for maintenance service and transmitting a request for bids related to the request for maintenance service to a plurality of prescreened bidders, the bidders including maintenance service providers. The method also includes receiving at least one bid for access to identification information of the equipment assembly, evaluating the at least one bid with respect to predetermined evaluation parameters, and selecting one of the plurality of prescreened bidders to award the bid. Further, the method includes notifying the selected one of the plurality of prescreened bidders of the award of the bid, receiving a payment for the award from the selected one of the plurality of prescreened bidders, and transmitting access to identification information of the equipment assembly to the selected one of the plurality of prescreened bidders.

In another aspect, a service matching system (SMS) includes an equipment assembly including a condition monitoring module and a communications module. The condition monitoring module is configured to monitor a performance of the equipment assembly through sensing equipment that monitor an environment or operating parameters in or near the equipment assembly. The communications module is configured to transmit a status of the equipment assembly based on a periodic assessment by the condition monitoring module. The SMS also includes a maintenance service matching module including at least one or more processors and one or more memory devices communicatively coupled to the one or more processors. The maintenance service matching module is communicatively couplable to a plurality of maintenance service provider computing devices and the equipment assembly through at least one of the communications module and a user computing device. The maintenance service matching module is configured to receive at least one of a request for maintenance service and a set of acquired operating parameters of the equipment assembly, determine a potential scope of maintenance work for the equipment assembly based on at least one of the received request for maintenance service and the received set of acquired operating parameters, transmit a request for bids related to the request for maintenance service to a plurality of prescreened bidders, the bidders including maintenance service providers, and receive at least one bid for access to identification information of the equipment assembly.

In yet another aspect, one or more non-transitory computer-readable storage media having computer-executable instructions embodied thereon are provided. When executed by at least one processor, the computer-executable instructions cause the processor to receive at least one of a request for maintenance service and a set of acquired operating parameters of the equipment assembly, determine a potential scope of maintenance work for the equipment assembly based on at least one of the received request for maintenance service and the received set of acquired operating parameters, transmit a request for bids related to the request for maintenance service to a plurality of prescreened bidder computing devices, the bidder computing devices associated with maintenance service providers, and receive at least one bid for access to identification information of the equipment assembly.

Various refinements exist of the features noted in relation to the above-mentioned aspects. Further features may also be incorporated in the above-mentioned aspects as well. These refinements and additional features may exist individually or in any combination. For instance, various features discussed below in relation to any of the illustrated embodiments may be incorporated into any of the above-described aspects, alone or in any combination.

### BRIEF DESCRIPTION OF THE DRAWINGS

FIGS. 1-7 show example embodiments of the methods and systems described herein.

FIG. 1 is a schematic block diagram of a service matching system (SMS) in accordance with an example embodiment of the present disclosure.

FIG. 2 is a simplified block diagram of the SMS including a plurality of computer devices including a maintenance service matching module in accordance with one example embodiment of the present disclosure.

FIG. 3 illustrates an example configuration of a user system operated by a user.

FIG. 4 illustrates an example configuration of a server system such as the server system shown in FIGS. 1 and 2.

FIG. 5 is a flow chart of a method of providing maintenance service request information to maintenance service providers.

FIG. 6 is a block diagram of a system architecture that may be used with the service matching system shown in FIG. 1.

FIG. 7 is a flow chart of an embodiment of the service matching system shown in FIG. 1

Like reference symbols in the various drawings indicate like elements.

### DETAILED DESCRIPTION

Embodiments of the methods and systems described herein relate to a system and method for matching service providers, particularly maintenance service providers with users having a maintenance service need. In one embodiment, a manufacturer of equipment or other third party matches providers with users via an auction system. The winning bidder in the auction receives the user's contact information so that the maintenance service provider can contact the user to offer maintenance services. The manufacturer or third party are alerted to the need for maintenance service either by the user who contacts the manufacturer via phone, email, web portal, or the like to request maintenance service, or through an automated process resident on a third party server which continuously monitors data from the user's location, and determines if maintenance is required. The manufacturer or third party initiates the auction process, notifies prescreened qualified maintenance service providers of the auction beginning, and settles the transaction at the end of the auction period. The maintenance service provider auction system provides the user with a quick response to a maintenance issue by a qualified maintenance service provider, provides the maintenance service provider with readily actionable leads for a fee determined by the marketplace, and provides the manufacturer or third party with a stream of income for providing leads to the maintenance service providers. The maintenance service provider auction also permits the manufacturer some control over the quality of maintenance service providers that are called on to maintain equipment that they sold to the user by controlling which maintenance service providers are permitted to bid on maintenance service requests. As used herein, prescreening refers to a process of evaluating a maintenance service provider's past maintenance history and adherence to agreed-upon performance indicators, for example, a timeliness on the project, a cleanliness associated with the project, a price compared to the competition, a quality of the work performed, a communication before, during and after the project, and/or professionalism throughout the project.

To control which maintenance service providers are permitted to bid on maintenance service requests, the manufacturer, or third party is able to charge potential maintenance service providers a fee for the right to bid on maintenance service requests and is also able qualify each maintenance service provider based on feedback from users and other criteria. In this way, the manufacturer, or third party, is able to ensure only the best maintenance service providers are able to bid on the maintenance service requests.

The bid process reveals only enough information to the maintenance service providers to assess the level of maintenance service being requested. Such information may include the nature of the maintenance service being requested and identifying information for the equipment assembly, such as, but not limited to a model number of the equipment assembly. The bid process does not reveal the contact information of the user or the decision-maker in charge of the equipment assembly for which maintenance service is being requested until after the bid process is complete and the financial arrangements of the bid have been settled.

In one embodiment, a computer program is provided, and the program is embodied on a computer readable medium. In an example embodiment, the system is executed on a single computer system, without requiring a connection to a sever computer. In a further example embodiment, the system is being run in a Windows® environment (Windows is a registered trademark of Microsoft Corporation, Redmond, Wash.). In yet another embodiment, the system is run on a mainframe environment and a UNIX® server environment (UNIX is a registered trademark of AT&T located in New York, N.Y.). The application is flexible and designed to run in various different environments without compromising any major functionality. In some embodiments, the system includes multiple components distributed among a plurality of computing devices. One or more components may be in the form of computer-executable instructions embodied in a computer-readable medium. The systems and processes are not limited to the specific embodiments described herein. In addition, components of each system and each process can be practiced independent and separate from other components and processes described herein. Each component and process can also be used in combination with other assembly packages and processes.

As used herein, the term “database” may refer to either a body of data, a relational database management system (RDBMS), or to both. A database may include any collection of data including hierarchical databases, relational databases, flat file databases, object-relational databases, object oriented databases, and any other structured collection of records or data that is stored in a computer system. The above examples are for example only, and thus are not intended to limit in any way the definition and/or meaning of the term database. Examples of RDBMS's include, but are not limited to including, Oracle® Database, MySQL, IBM® DB2, Microsoft® SQL Server, Sybase®, and PostgreSQL. However, any database may be used that enables the systems and methods described herein. (Oracle is a registered trademark of Oracle Corporation, Redwood Shores, California; IBM is a registered trademark of International Business Machines Corporation, Armonk, N.Y.; Microsoft is a registered trademark of Microsoft Corporation, Redmond, Wash.; and Sybase is a registered trademark of Sybase, Dublin, Calif.)

The following detailed description illustrates embodiments of the disclosure by way of example and not by way of limitation. It is contemplated that the disclosure has general application to processing service information by a third party in industrial, commercial, and residential applications.

As used herein, an element or step recited in the singular and proceeded with the word “a” or “an” should be understood as not excluding plural elements or steps, unless such exclusion is explicitly recited. Furthermore, references to “example embodiment” or “one embodiment” of the present disclosure are not intended to be interpreted as excluding the existence of additional embodiments that also incorporate the recited features.

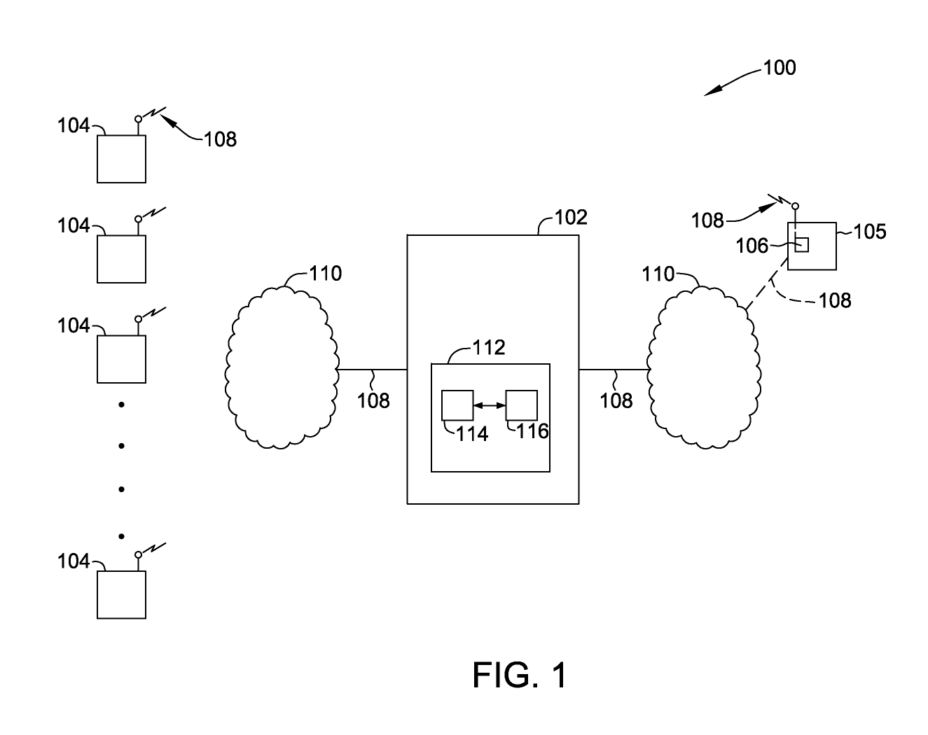

FIG. 1 is a schematic block diagram of a service matching system (SMS) 100 in accordance with an example embodiment of the present disclosure. In the example embodiment, a third party service matching provider, for example, but not limited to a manufacturer, or third party computing system 102 is communicatively coupled to a plurality of maintenance service provider (MSP) computer systems 104 and at least one user computing device 106, such as, a homeowner, commercial business owner, or other such decision-maker for an equipment assembly 105. Computing system 102 includes a maintenance service matching module 112 including at least one or more processors 114 and one or more memory devices 116. Computing system 102 may be communicatively coupled to MSP computer systems 104 and user computing devices 106 wirelessly or via any type of signal conduit 108 that permits SMS 100 to perform as described herein. For example, computing system 102, MSP computer systems 104, and user computing device 106 may be communicatively coupled to a network, such as, but not limited to the Internet 110 using electromagnetic signals, including light, metallic wires, optic fibers, combinations thereof, and the like. In various embodiments, user computing device 106 may be embodied in for example, a smart phone or tablet configured for input directly by the user. In other embodiments, user computing device 106 is a part of equipment assembly 105. For example, a monitoring system to monitor performance of equipment assembly 105 or sensing equipment configured to monitor an environment or process parameters in or near equipment assembly 105. One example of such sensing equipment is a Sensi™ thermostat available from Emerson Electric Co., St. Louis, Mo. Data acquired or generated by the thermostat is transmitted to computing system 102. Such data could include, for example, current setpoint, current sensed temperature (the ambient indoor temperature), system mode (heating or cooling or off), and whether or not equipment assembly is currently on or off and the like. Computing system 102 receives this information as per user account information, and would use a set of algorithms to determine whether or not the systems needed attention. Although a thermostat that is typical of industrial, commercial, and residential heating, ventilation, and air conditioning systems, the description herein also applies to other appliances, equipment, and monitoring system as well. For example, a refrigerator, swimming pool filtration and circulation equipment, elevator and escalator system may all have monitoring systems that can determine and or generate a maintenance alert to begin the process describe herein.

In various embodiments, the thermostat can only make a broad assessment that something in the system is wrong, but may not be able to identify the component. Typically this would be done by having the algorithm determine the run time of the system as a function of the rate of temperature change in standby (i.e. the thermostat monitors the rate at which heat is lost or gained when the system is off, and this rate is used by the server algorithm for comparison to run times for similar rates in the past).

Additionally, the algorithm could use the difference between the sensed indoor temperature, and the outdoor temperature to determine if for a given historical difference between the indoor and outdoor temperature, the system is now running 10% longer than last year when this temperature difference was detected, for example. This second method requires that the outside temperature be known. This temperature could be acquired from an outdoor sensor connected to the thermostat, or pulled from a remote server via the zip code of the user account.

In other embodiments, one or more data modules in addition to ancillary devices like a transformer and a router are installed on an equipment assembly. The information sent by the data modules (an aggregate measurement of indoor unit and outdoor unit current and voltage) enables the algorithm on the server to identify the system component most likely to be the cause of the problem. The additional information is relatively more granular in what is output from the server, and a maintenance service provider will more readily be able to determine what the source of the maintenance service request is and therefore parts and tools are needed for the maintenance service.

So whereas in some embodiments the data can only provide an indication that the system is compromised, other embodiments can indicate what component in equipment assembly 105 has failed. It is possible that a single location associated with a user could have a plurality of different equipment assemblies installed with a number of different data schemes available. Given the nature of the differences in the data from the different embodiments it is likely the server algorithms for each would be different. The algorithms may be located on the same server, or different servers.

When an algorithm determines that a problem exists maintenance service request information is transmitted to maintenance service providers in accordance with the methods described further herein below. A notice is transmitted to the user via email, an app notification, social media notification, a short message system (SMS) message, or other electronic communication. Simultaneously or sequentially, service matching system 100 may transmit the notice to the maintenance service provider. The user would simply get a notice that an issue has been detected, and they will be contacted by a maintenance service provider. The maintenance service provider would get notification that an issue has occurred, and would have to respond with the designated payment, if he wanted to respond to it. If the maintenance service provider paid the fee, then the maintenance service provider would get information pertaining to the fault, such as the user name and phone number. The information would also outline the nature of the fault and the component(s) most likely to be the cause, allowing the maintenance service provider to contact the user with a cause and a price to fix it. In some embodiments, the maintenance service provider may not be able to accurately determine a cause of the alert if the monitoring system was unable to provide sufficient information and thus not be able to provide an estimate until he was actually on site, and could inspect the system.

Should the maintenance service provider first alerted not choose to accept possible repair, the notice would then be sent to other maintenance service providers whose contact information would be stored in, for example, database 102, as a function of the zip code or other locator of the user account. The maintenance service providers, filtered by zip code (or perhaps a radius from the user zip code), then have the opportunity to bid for the information in the notice; i.e. the user name, address, phone number or other contact information, and the nature of the fault. Should they win the bid, the information will then be delivered to them.

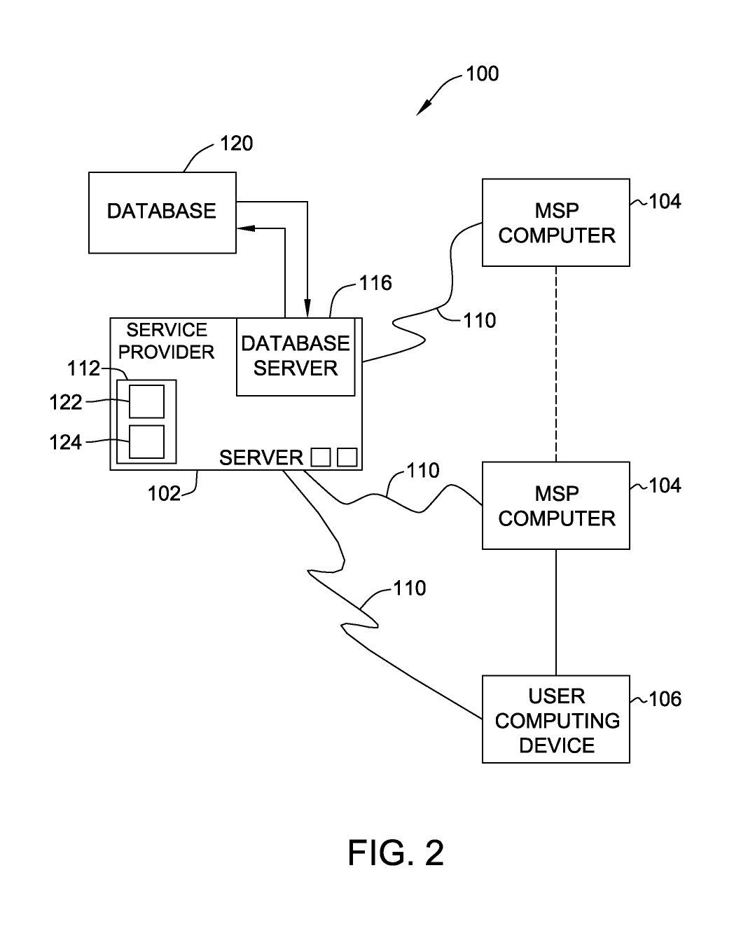

FIG. 2 is a simplified block diagram of SMS 100 including a plurality of computer devices including maintenance service matching module 112 in accordance with one example embodiment of the present disclosure. In the example embodiment, the plurality of computer devices includes, for example, computing system 102, MSP computer systems 104, auction platform module 122, transaction platform 124, and user computing device 106. In one embodiment, SMS 100 implements a process to match maintenance service providers with users requesting maintenance service. More specifically, auction platform module 122 in communication with computing system 102 is configured to receive information relating to a service request by a user, and store the information in a memory device as one of a plurality of information items for a plurality of maintenance service requests. Auction platform module 122 is also configured to transmit the information relating to a maintenance service request to selectable maintenance service providers. In some embodiments, transaction platform 124 and/or auction platform module 122 interact with the selected maintenance service providers to control the dissemination of the information relating to the maintenance service request. Auction platform module 122 is further configured to enable bidding on maintenance service request information over social media outlets.

More specifically, in the example embodiment, SMS 100 includes a manufacturer, or third party, computing system 102, and a plurality of client sub-systems, also referred to as MSP computer systems 104, connected to computing system 102. In one embodiment, MSP computer systems 104 are computers including a web browser, such that computing system 102 is accessible to MSP computer systems 104 using the Internet. MSP computer systems 104 are interconnected to the Internet through many interfaces including a network, such as a local area network (LAN) or a wide area network (WAN), dial-in-connections, cable modems, and special high-speed Integrated Services Digital Network (ISDN) lines. MSP computer systems 104 could be any device capable of interconnecting to the Internet including a web-based phone, PDA, or other web-based connectable equipment.

SMS 100 also includes user computing device 106, which may be connected to MSP computer systems 104 and may be connected to computing system 102. User computing devices 106 are interconnected to the Internet through many interfaces including a network, such as a local area network (LAN) or a wide area network (WAN), dial-in-connections, cable modems, wireless modems, and special high-speed ISDN lines. User computing devices 106 could be any device capable of interconnecting to the Internet and including an input device capable of reading information from a user computing device 106 or equipment assembly through user computing device 106 or directly.

A database server 116 is connected to database 120, which contains information on a variety of matters, as described below in greater detail. In one embodiment, centralized database 120 is stored on computing system 102 and can be accessed by potential users at one of MSP computer systems 104 by logging onto computing system 102 through one of MSP computer systems 104. In an alternative embodiment, database 120 is stored remotely from computing system 102 and may be non-centralized.

Database 120 may include a single database having separated sections or partitions or may include multiple databases, each being separate from each other. Database 120 may store received maintenance service requests from users. Database 120 may also store technical and identifying data regarding equipment assemblies associated with the received maintenance service requests. The technical and identifying data including at least one of a user's name, address, location of the affected equipment assembly, an account number associated with the user name or equipment assembly, model and serial numbers of equipment assembly 105, and other identifying information. Database 120 may store picture files associated with equipment assembly 105, map files including driving directions and/or geolocation information, instructions for facilitating the transaction, and other information to facilitate processing according to the method described in the present disclosure.

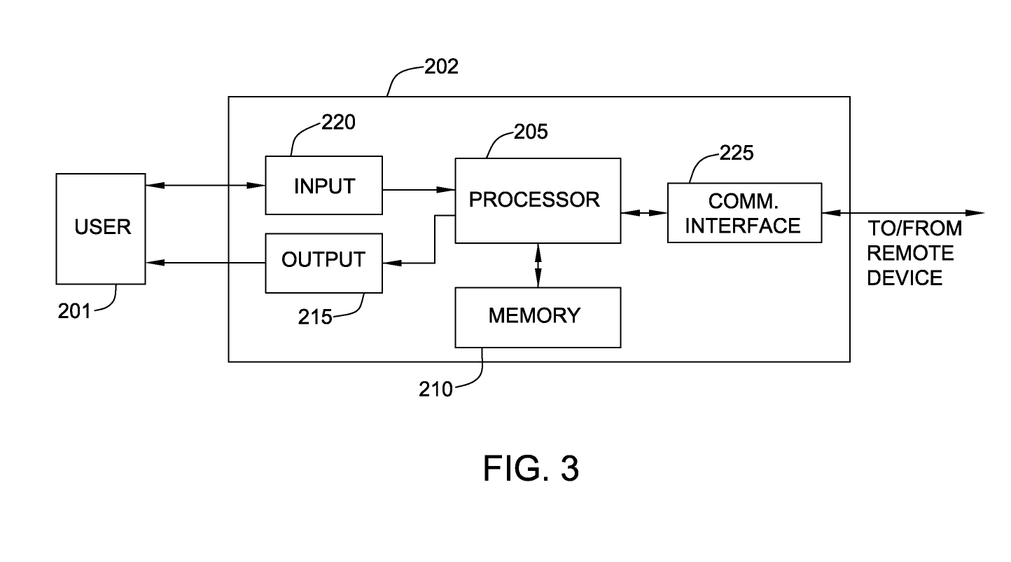

FIG. 3 illustrates an example configuration of a user system 202 operated by a user 201. User system 202 may include, but is not limited to, MSP computer systems 104 and user computing device 106. In the example embodiment, user system 202 includes a processor 205 for executing instructions. In some embodiments, executable instructions are stored in a memory area 210. Processor 205 may include one or more processing units, for example, a multi-core configuration. Memory area 210 is any device allowing information such as executable instructions and/or written works to be stored and retrieved. Memory area 210 may include one or more computer readable media.

User system 202 also includes at least one output component 215 for presenting information to user 201. Output component 215 is any component capable of conveying information to user 201. In some embodiments, output component 215 includes an output adapter such as a video adapter and/or an audio adapter. An output adapter is operatively coupled to processor 205 and operatively couplable to an output device such as a display device, a liquid crystal display (LCD), organic light emitting diode (OLED) display, or “electronic ink” display, or an audio output device, a speaker or headphones.

In some embodiments, user system 202 includes an input device 220 for receiving input from user 201. Input device 220 may include, for example, a keyboard, a pointing device, a mouse, a stylus, a touch sensitive panel, a touch pad, a touch screen, a gyroscope, an accelerometer, a position detector, or an audio input device. A single component such as a touch screen may function as both an output device of output component 215 and input device 220. User system 202 may also include a communication interface 225, which is communicatively couplable to a remote device such as computing system 102. Communication interface 225 may include, for example, a wired or wireless network adapter or a wireless data transceiver for use with a mobile phone network, Global System for Mobile communications (GSM), 3G, or other mobile data network or Worldwide Interoperability for Microwave Access (WIMAX).

Stored in memory area 210 are, for example, computer readable instructions for providing a user interface to user 201 via output component 215 and, optionally, receiving and processing input from input device 220. A user interface may include, among other possibilities, a web browser and client application. Web browsers enable users, such as user 201, to display and interact with media and other information typically embedded on a web page or a website from computing system 102. A client application allows user 201 to interact with a server application from computing system 102.

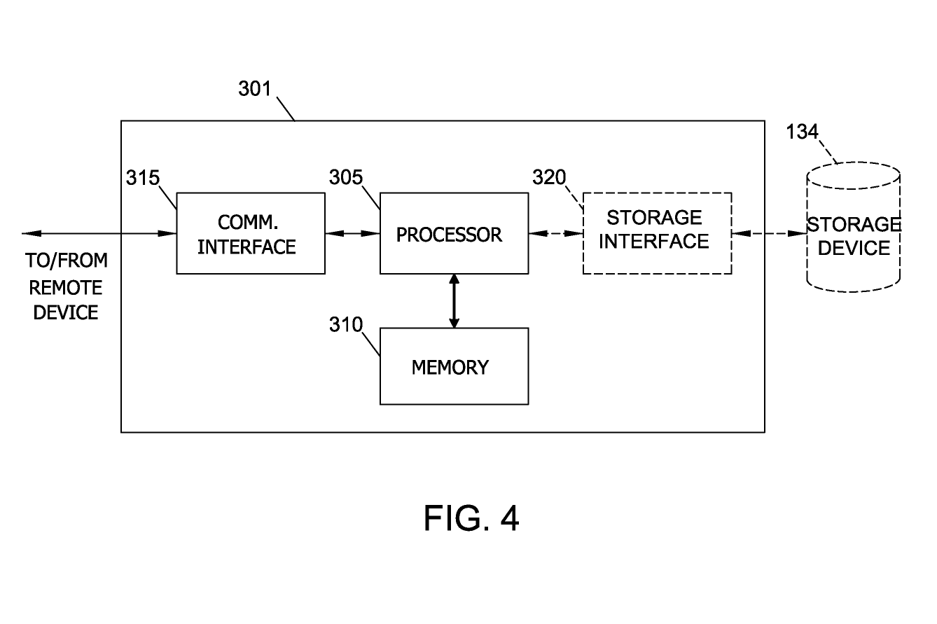

FIG. 4 illustrates an example configuration of a server system 301 such as computing system 102 (shown in FIGS. 1 and 2). Server system 301 may include, but is not limited to, database server 116 (shown in FIGS. 1 and 2).

Server system 301 includes a processor 305 for executing instructions. Instructions may be stored in a memory area 310, for example. Processor 305 may include one or more processing units (e.g., in a multi-core configuration) for executing instructions. The instructions may be executed within a variety of different operating systems on the server system 301, such as UNIX, LINUX, Microsoft Windows®, etc. It should also be appreciated that upon initiation of a computer-based method, various instructions may be executed during initialization. Some operations may be required in order to perform one or more processes described herein, while other operations may be more general and/or specific to a particular programming language (e.g., C, C#, C++, Java, or other suitable programming languages, etc.).

Server system 301 may be communicatively coupled to auction platform module 122, and/or transaction platform 124. Auction platform module 122 in communication with computing system 102 is configured to receive information relating to a maintenance service request from a user, and store the information in a memory device as one of a plurality of information items for preparing a request for bids from a plurality of maintenance service providers. Auction platform module 122 is also configured to transmit the information relating to the maintenance service request to selectable social media outlets associated with the manufacturer. Using social media to notify maintenance service providers of a request for bids increases awareness by the maintenance service providers and improves a response rate to the request for bids. In the example embodiment, auction platform module 122 may be external to server system 301 and may be accessed by multiple server systems 301. For example, auction platform module 122 may be a computing device coupled to a memory unit. In some embodiments, auction platform module 122 may be integrated with server system 301. For example, auction platform module 122 may be a specifically programmed section of server system 301 configured to perform the functions described herein when executed by processor 305.

Processor 305 is operatively coupled to a communication interface 315 such that server system 301 is capable of communicating with a remote device such as a user system or another server system 301. For example, communication interface 315 may receive requests from user computing device 106 via Internet 110, as illustrated in FIGS. 1 and 2.

Processor 305 may also be operatively coupled to a storage device 134. Storage device 134 is any computer-operated hardware suitable for storing and/or retrieving data. In some embodiments, storage device 134 is integrated in server system 301. For example, server system 301 may include one or more hard disk drives as storage device 134. In other embodiments, storage device 134 is external to server system 301 and may be accessed by a plurality of server systems 301. For example, storage device 134 may include multiple storage units such as hard disks or solid state disks in a redundant array of inexpensive disks (RAID) configuration. Storage device 134 may include a storage area network (SAN) and/or a network attached storage (NAS) system.

In some embodiments, processor 305 is operatively coupled to storage device 134 via a storage interface 320. Storage interface 320 is any component capable of providing processor 305 with access to storage device 134. Storage interface 320 may include, for example, an Advanced Technology Attachment (ATA) adapter, a Serial ATA (SATA) adapter, a Small Computer System Interface (SCSI) adapter, a RAID controller, a SAN adapter, a network adapter, and/or any component providing processor 305 with access to storage device 134.

Memory area 310 may include, but are not limited to, random access memory (RAM) such as dynamic RAM (DRAM) or static RAM (SRAM), read-only memory (ROM), erasable programmable read-only memory (EPROM), electrically erasable programmable read-only memory (EEPROM), and non-volatile RAM (NVRAM). The above memory types are examples only, and are thus not limiting as to the types of memory usable for storage of a computer program.

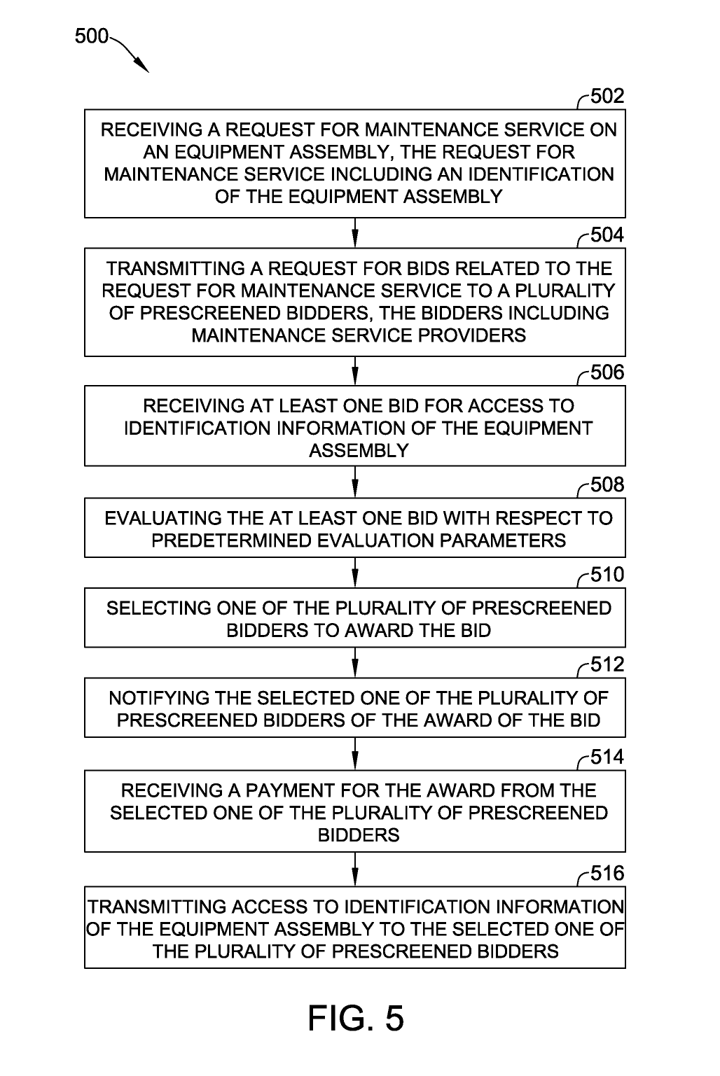

FIG. 5 is a flow chart of a method 500 of providing maintenance service request information to maintenance service providers. In the example embodiment, method 500 is implemented using one or more processors coupled to one or more memory devices. Method 500 includes receiving 502 a request for maintenance service on an equipment assembly, the request for maintenance service including an identification of equipment assembly 105. The received request for maintenance service may also include an indication of a failure of equipment assembly 105 and/or a performance degradation of equipment assembly 105. In various embodiments, the request is automatically output from computing system 102, which is communicatively coupled to one or more monitoring devices coupled to equipment assembly 105. In other embodiments, the request is received from a user of equipment assembly 105 or other decision-maker with control over the operation or maintenance of equipment assembly 105. The user can access a web portal configured to post maintenance service requests from a plurality of users and that is accessible to a plurality of maintenance service providers.

Method 500 also includes transmitting 504 a request for bids related to the request for maintenance service to a plurality of prescreened bidders, the bidders including maintenance service providers, receiving 506 at least one bid for access to identification information of equipment assembly 105, and evaluating 508 the at least one bid with respect to predetermined evaluation parameters. Transmitting the request for bids to the plurality of prescreened bidders is done using at least one of an electronic communication including bid information, an electronic communication including a link to the bid information, a notification of a posting of the request for bids to a web portal. An important consideration for communication with the maintenance service provider is timeliness. Having an equipment assembly that needs maintenance is typically a high priority consideration for the user, the maintenance service providers will need to be notified of the maintenance service request available for bidding quickly, as the bidding window will be relatively short, and the maintenance service performed relatively quickly. The request for bids will typically include identification information for equipment assembly 105 for which the request for service is being made and a nature of the problem prompting the maintenance service request. In some embodiments, one maintenance service provider, such as, the maintenance service provider that sold equipment assembly 105 to the homeowner or decision-maker, may be given a right to first refusal to satisfy the maintenance service request for the identified equipment assembly prior to transmitting the request to others of the plurality of prescreened bidders. Such a right of first refusal may also be purchased from computing system 102 for a fee. The fee may be variable based on the installed equipment assembly, for example, the size of the installation or age of the installation.

The bids are evaluated according to at least a proficiency of the bidder, a performance rating of the bidder, and/or a timeliness commitment of the bidder. For example, some maintenance service requests require near immediate response of the maintenance service provider due to the nature of the request, in which case the maintenance service provider would have to commit to providing service on a priority basis. Such priority may be required in cases where equipment assembly 105 is medically necessary or otherwise important to safety. In bitterly cold weather, a maintenance service request indicating a complete failure of a heating equipment assembly may require priority service. Similarly, a complete failure of a cooling equipment assembly may also require priority service. If a maintenance service provider cannot commit to such priority service, the maintenance service provider may be disqualified from that round of bidding and if the maintenance service provider makes the commitment during the bidding process, but then does not provide the priority service, the maintenance service provider may be assessed a fee and/or be banned from future bidding for a determined period of time.

Method 500 further includes selecting 510 one of the plurality of prescreened bidders to award the bid, notifying 512 the selected one of the plurality of prescreened bidders of the award of the bid, receiving 514 a payment for the award from the selected one of the plurality of prescreened bidders, and transmitting 514 access to identification information of equipment assembly 105 to the selected one of the plurality of prescreened bidders. Method 500 further includes transmitting 516 access to identification information of the equipment assembly to the selected one of the plurality of prescreened bidders. Access to the identification information may be in the form of a link to a network location where the identification information is stored. Access to the identification information may be in the form of content of an email, SMS or other message.

Method 500 further optionally includes evaluating a performance of a maintenance service provider with respect to services performed on other equipment assemblies. The evaluation may include subjective criteria, such as, but not limited to, results of a survey of the homeowner or decision-maker about the performance of the maintenance service provider. The evaluation may also include objective criteria, such as, but not limited to, financial performance of the maintenance service provider with respect to other maintenance service providers on other similar work generated by leads received through computing system 102.

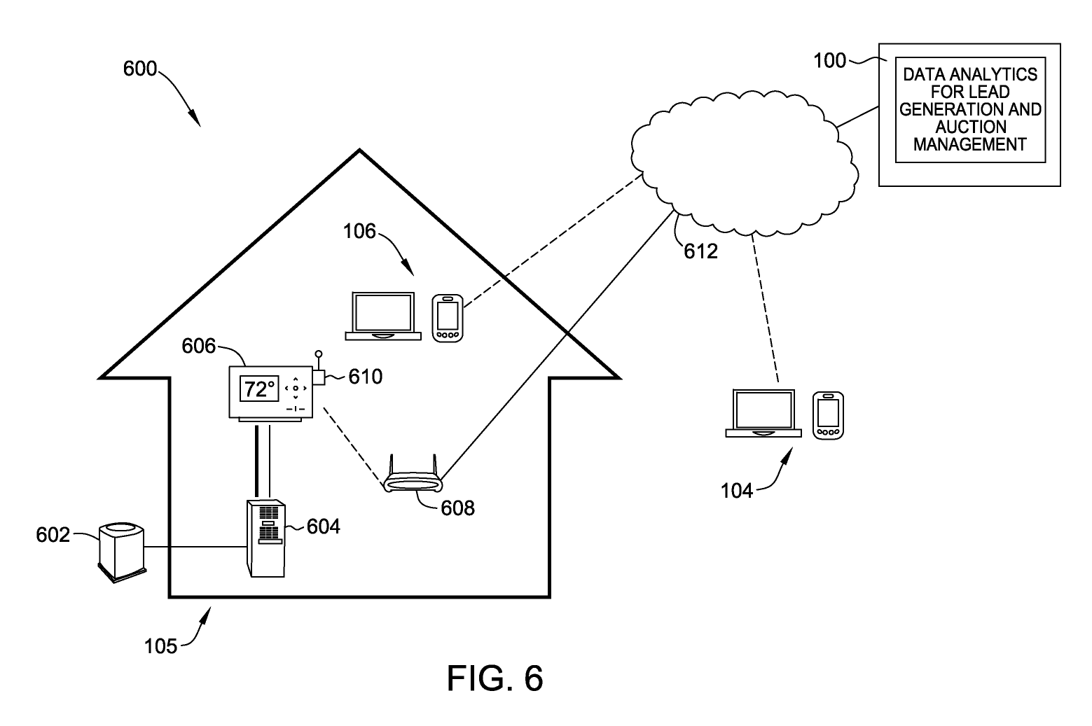

FIG. 6 is a schematic diagram of a system architecture 600 of the service matching system (SMS) 100 shown in FIG. 1. In the example embodiment, equipment assembly 105, such as, but not limited to a residential heating and air conditioning system includes a condenser unit 602, air handler/furnace unit 604 and a controller 606, such as, a thermostat. Controller 606 is configured to control and also monitor the operation of equipment assembly 105. In some embodiments, the control and monitor functions of controller 606 is robust, meaning many parameters are monitored and more than one relatively complex algorithms are used to determine potential faults or deteriorated performance of equipment assembly 105. In other embodiments, controller 606 may have a limited monitoring and diagnosis capability. Controller 606 is communicatively coupled to a network access point 608 through an equipment assembly communications device 610, if equipped. In an embodiment, network access point 608 may be embodied in a modem/router combination where the communication is either wireless or wired. In one embodiment, network access point 608 is a combination of two separate devices, for example, a wireless router and a separate modem connected to a network, such as, the Internet 612. Alternatively, a homeowner may enter alert information displayed on equipment assembly 105 using user computing device 106, embodied in a personal computer (PC) format or in a smartphone/tablet format. User computing device 106 may access network 612 directly or through network access point 608. SMS 100 is communicatively coupled to network 612. Equipment assembly 105 information is received by SMS 100 for processing as described herein. Maintenance service provider (MSP) computer systems 104 are also communicatively coupled to network 612.

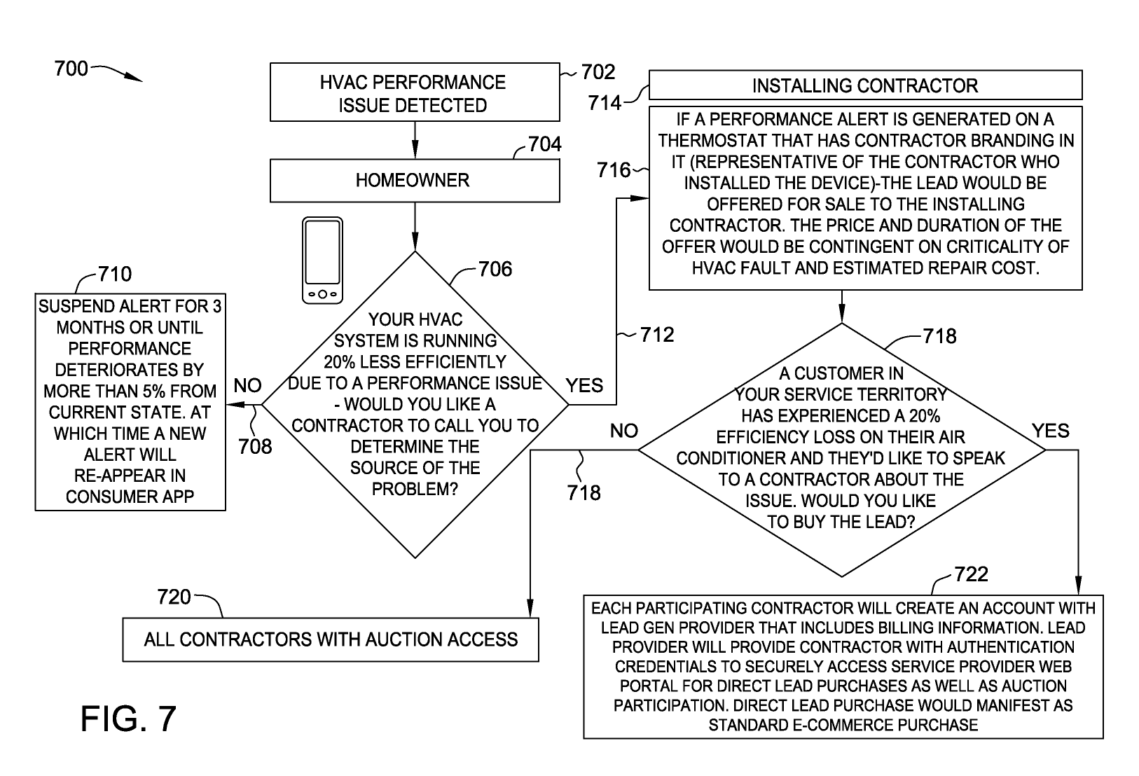

FIG. 7 is a process flow diagram 700 of a method of managing a lead generation process for maintenance services. In the example embodiment, a user 704 such as a homeowner, is made aware of a problem with equipment assembly 105 by an alert 702 generated by controller 606. A user interface prompts 706 user 704 for approval of soliciting bids for maintenance services based on the generated alert. The prompt may be displayed on controller 606 or on user computing device 106 running an app programmed to manage communications between SMS 100 and user 704. The prompt may also be transmitted to user 704 via an electronic message. If user 704 responds negatively 708 to the prompt, controller 606 sets a reminder 710 for a predetermined period of time and/or a continued degradation of performance beyond a threshold range. Controller 606 retransmits the prompt at the expired predetermined period of time or when the performance of equipment assembly 105 degrades beyond the threshold range. If user 704 responds affirmatively 712 to the prompt, a first contractor entity 714, such as the installing contractor is solicited for performing 716 the maintenance service at a prearranged price and service agreement. If first contractor entity 714 declines 718 the maintenance service request, the maintenance service request is provided to all contractors with auction access 720. After winning the auction, the maintenance service request is awarded to the winning bidder along with information 722 on accessing the identification of the faulted equipment assembly 105 and any further instructions, for example, directions to the location, specifications for equipment assembly 105, and other terms.

The term processor, as used herein, refers to central processing units, microprocessors, microcontrollers, reduced instruction set circuits (RISC), application specific integrated circuits (ASIC), logic circuits, and any other circuit or processor capable of executing the functions described herein.

As used herein, the terms “software” and “firmware” are interchangeable, and include any computer program stored in memory for execution by mobile devices, clusters, personal computers, workstations, clients, servers, and processor 205, 305 wherein the memory includes RAM memory, ROM memory, EPROM memory, EEPROM memory, and non-volatile RAM (NVRAM) memory. The above memory types are examples only, and are thus not limiting as to the types of memory usable for storage of a computer program.

As will be appreciated based on the foregoing specification, the above-discussed embodiments of the disclosure may be implemented using computer programming or engineering techniques including computer software, firmware, hardware or any combination or subset thereof Any such resulting program, having computer-readable and/or computer-executable instructions, may be embodied or provided within one or more computer-readable media, thereby making a computer program product, i.e., an article of manufacture, according to the discussed embodiments of the disclosure. The computer readable media may be, for instance, a fixed (hard) drive, diskette, optical disk, magnetic tape, semiconductor memory such as read-only memory (ROM) or flash memory, etc., or any transmitting/receiving medium such as the Internet or other communication network or link. The article of manufacture containing the computer code may be made and/or used by executing the instructions directly from one medium, by copying the code from one medium to another medium, or by transmitting the code over a network.

The technical effect of the methods and systems may be achieved by performing at least one of the following steps: (a) receiving a request for maintenance service on an equipment assembly, the request for maintenance service including an identification of equipment assembly 105, (b) transmitting a request for bids related to the request for maintenance service to a plurality of prescreened bidders, the bidders including maintenance service providers, (c) receiving at least one bid for access to identification information of equipment assembly 105, (d) evaluating the at least one bid with respect to predetermined evaluation parameters, (e) selecting one of the plurality of prescreened bidders to award the bid, (f) notifying the selected one of the plurality of prescreened bidders of the award of the bid, (g) receiving a payment for the award from the selected one of the plurality of prescreened bidders, and (h) transmitting access to identification information of equipment assembly 105 to the selected one of the plurality of prescreened bidders.

As used herein, the term “non-transitory computer-readable media” is intended to be representative of any tangible computer-based device implemented in any method or technology for short-term and long-term storage of information, such as, computer-readable instructions, data structures, program modules and sub-modules, or other data in any device. Therefore, the methods described herein may be encoded as executable instructions embodied in a tangible, non-transitory, computer readable medium, including, without limitation, a storage device and/or a memory device. Such instructions, when executed by a processor, cause the processor to perform at least a portion of the methods described herein. Moreover, as used herein, the term “non-transitory computer-readable media” includes all tangible, computer-readable media, including, without limitation, non-transitory computer storage devices, including, without limitation, volatile and nonvolatile media, and removable and non-removable media such as a firmware, physical and virtual storage, CD-ROMs, DVDs, and any other digital source such as a network or the Internet, as well as yet to be developed digital means, with the sole exception being a transitory, propagating signal.

As used herein, the term “computer” and related terms, e.g., “computing device”, are not limited to integrated circuits referred to in the art as a computer, but broadly refers to a microcontroller, a microcomputer, a programmable logic controller (PLC), an application specific integrated circuit, and other programmable circuits, and these terms are used interchangeably herein.

As used herein, the term “cloud computing” and related terms, e.g., “cloud computing devices” refers to a computer architecture allowing for the use of multiple heterogeneous computing devices for data storage, retrieval, and processing. The heterogeneous computing devices may use a common network or a plurality of networks so that some computing devices are in networked communication with one another over a common network but not all computing devices. In other words, a plurality of networks may be used in order to facilitate the communication between and coordination of all computing devices.

As used herein, the term “mobile computing device” refers to any of computing device which is used in a portable manner including, without limitation, smart phones, personal digital assistants (“PDAs”), computer tablets, hybrid phone/computer tablets (“phablet”), or other similar mobile device capable of functioning in the systems described herein. In some examples, mobile computing devices may include a variety of peripherals and accessories including, without limitation, microphones, speakers, keyboards, touchscreens, gyroscopes, accelerometers, and metrological devices. Also, as used herein, “portable computing device” and “mobile computing device” may be used interchangeably.

Approximating language, as used herein throughout the specification and claims, may be applied to modify any quantitative representation that could permissibly vary without resulting in a change in the basic function to which it is related. Accordingly, a value modified by a term or terms, such as “about” and “substantially”, are not to be limited to the precise value specified. In at least some instances, the approximating language may correspond to the precision of an instrument for measuring the value. Here and throughout the specification and claims, range limitations may be combined and/or interchanged, such ranges are identified and include all the sub-ranges contained therein unless context or language indicates otherwise.

The above-described embodiments of a method and system of communicating maintenance service requests to a plurality of pre-qualified maintenance service providers provides a cost-effective and reliable means for receiving the maintenance service requests from users and monetizing that information by hosting a bidding process for the contact information of the user by the maintenance service providers. More specifically, the methods and systems described herein facilitate aligning maintenance service providers that are interested in performing the maintenance associated with the maintenance service request with the user in-charge of equipment assembly. In addition, the above-described methods and systems facilitate reduce the cost of lead generation for the maintenance service providers. As a result, the methods and systems described herein facilitate providing users and maintenance service providers an avenue for quick communication in a cost-effective and reliable manner.

When introducing elements of the present disclosure or the embodiment(s) thereof, the articles “a”, “an”, “the” and “said” are intended to mean that there are one or more of the elements. The terms “comprising,” “including,” “containing” and “having” are intended to be inclusive and mean that there may be additional elements other than the listed elements. The use of terms indicating a particular orientation (e.g., “top”, “bottom”, “side”, etc.) is for convenience of description and does not require any particular orientation of the item described.

As various changes could be made in the above constructions and methods without departing from the scope of the disclosure, it is intended that all matter contained in the above description and shown in the accompanying drawing(s) shall be interpreted as illustrative and not in a limiting sense.

1. A computer-based method for providing maintenance service request information to maintenance service providers, the method implemented using a computer device coupled to a memory device, the method comprising:
prescreening a plurality of maintenance service providers, the prescreening evaluating a historical performance of each of the plurality of maintenance service providers and an agreement to quality in future performance of providing maintenance services;
receiving, by the computer device, a request for maintenance service on an equipment assembly, the request for maintenance service including an identification of the equipment assembly;
transmitting a request for bids related to the request for maintenance service to a plurality of prescreened bidders, the bidders including maintenance service providers;
receiving, by the computer device, at least one bid for access to identification information of the equipment assembly;
evaluating the at least one bid with respect to predetermined evaluation parameters;
selecting one of the plurality of prescreened bidders to award the bid;
notifying the selected one of the plurality of prescreened bidders of the award of the bid;
receiving a payment for the award from the selected one of the plurality of prescreened bidders; and
transmitting access to identification information of the equipment assembly to the selected one of the plurality of prescreened bidders.

2. The computer-based method of claim 1, wherein receiving a request for maintenance service on an equipment assembly comprises automatically receiving the request from a monitoring device communicatively coupled to the equipment assembly.

3. The computer-based method of claim 1, wherein receiving a request for maintenance service on an equipment assembly comprises receiving the request from a user accessing a web portal configured to post a maintenance service request accessible to a plurality of maintenance service providers.

4. The computer-based method of claim 1, wherein receiving a request for maintenance service on an equipment assembly comprises receiving an indication of at least one of a failure of the equipment assembly and a performance degradation of the equipment assembly.

5. The computer-based method of claim 1, further comprising evaluating a performance of a maintenance service provider with respect to services performed on other equipment assemblies.

6. The computer-based method of claim 1, wherein receiving a bid for access to identification information of the equipment assembly comprises retrieving identification information for the equipment assembly that includes contact information for a decision-maker for the equipment assembly.

7. The computer-based method of claim 1, wherein evaluating the at least one bid with respect to predetermined evaluation parameters comprises evaluating the at least one bid with respect to at least one of a proficiency of the bidder, a performance rating of the bidder, and a timeliness commitment of the bidder.

8. The computer-based method of claim 1, wherein transmitting a request for bids related to the request for maintenance service comprises transmitting a request for bids related to the request for maintenance service to a bidder having a right to first refusal for the identified equipment assembly prior to transmitting the request to others of the plurality of prescreened bidders.

9. The computer-based method of claim 1, wherein transmitting a request for bids related to the request for maintenance service to a plurality of prescreened bidders comprises transmitting the request for bids to the plurality of prescreened bidders via at least one of an electronic communication including bid information, an electronic communication including a link to the bid information, a notification of a posting of the request for bids to a web portal.

10. The computer-based method of claim 1, further comprising receiving an evaluation of one of the plurality of prescreened bidders with respect to maintenance service performed.

11. A service matching system (SMS) comprising:
an equipment assembly comprising a condition monitoring module and a communications module configured to transmit a status of said equipment assembly based on a periodic assessment by the condition monitoring module, said condition monitoring module configured to monitor a performance of said equipment assembly through sensing equipment configured to monitor an environment or operating parameters in or near said equipment assembly;
a maintenance service matching module comprising at least one or more processors and one or more memory devices communicatively coupled the one or more processors, said maintenance service matching module communicatively couplable to a plurality of maintenance service provider computing devices and said equipment assembly through at least one of said communications module and a user computing device, said maintenance service matching module configured to:
receive at least one of a request for maintenance service and a set of acquired operating parameters of said equipment assembly;
determine a potential scope of maintenance work for said equipment assembly based on at least one of the received request for maintenance service and the received set of acquired operating parameters;
transmit a request for bids related to the request for maintenance service to a plurality of prescreened bidders, the bidders including maintenance service providers; and
receive at least one bid for access to identification information of said equipment assembly.

12. The service matching system of claim 11, wherein said maintenance service matching module is further configured to receive at least one of a request for maintenance service and a set of acquired operating parameters of said equipment assembly directly from said equipment assembly through said communications module.

13. The service matching system of claim 11, wherein said maintenance service matching module is further configured to evaluate the at least one bid with respect to predetermined bid evaluation parameters;
select one of the plurality of prescreened bidders to award the bid;
notify the selected one of the plurality of prescreened bidders of the award of the bid;
receive a payment for the award from the selected one of the plurality of prescreened bidders; and
transmit access to identification information of the equipment assembly to the selected one of the plurality of prescreened bidders.

14. The service matching system of claim 11, wherein said user computing device is a part of the equipment assembly.

15. The service matching system of claim 11, wherein the operating parameters comprise a current setpoint, a current sensed temperature, a system mode, and a current state of the equipment assembly.

16. One or more non-transitory computer-readable storage media having computer-executable instructions embodied thereon, wherein when executed by at least one processor, the computer-executable instructions cause the processor to:
receive at least one of a request for maintenance service and a set of acquired operating parameters of said equipment assembly;
determine a potential scope of maintenance work for said equipment assembly based on at least one of the received request for maintenance service and the received set of acquired operating parameters;
transmit a request for bids related to the request for maintenance service to a plurality of prescreened bidder computing devices, the bidder computing devices associated with maintenance service providers; and
receive at least one bid for access to identification information of said equipment assembly.

17. The computer-readable storage media of claim 16, wherein the computer-executable instructions further cause the processor to:
evaluate the at least one bid with respect to predetermined bid evaluation parameters;
select one of the plurality of prescreened bidders to award the bid;
notify the selected one of the plurality of prescreened bidders of the award of the bid;
receive a payment for the award from the selected one of the plurality of prescreened bidders; and
transmit access to identification information of the equipment assembly to the selected one of the plurality of prescreened bidders.

18. The computer-readable storage media of claim 16, wherein the computer-executable instructions further cause the processor to receive at least one of a request for maintenance service and a set of acquired operating parameters of said equipment assembly directly from said equipment assembly through said communications module.

19. The computer-readable storage media of claim 16, wherein the computer-executable instructions further cause the processor to receive the set of acquired operating parameters of said equipment assembly with a preliminary determination of a source of a maintenance alert made by the equipment assembly.

20. The computer-readable storage media of claim 16, wherein the computer-executable instructions further cause the processor to compare historical operating parameter to at least one of a current setpoint, a current sensed temperature, a system mode, and a current state of the equipment assembly to determine a maintenance alert for the equipment assembly.
